(19) United States
(12) Patent Application Publication
(10) Pub. No.: US 2013/0103373 A1
(43) Pub. Date: Apr. 25, 2013

(54) ONLINE SIMULATION MODEL OPTIMIZATION

(71) Applicants: Jay W. Benayon, Vaughan (CA); Alex T. K. Lau, Markham (CA); Marin Litoiu, Toronto (CA); Andrei Solomon, Mississauga (CA); Vincent F. Szaloky, Toronto (CA)

(72) Inventors: Jay W. Benayon, Vaughan (CA); Alex T. K. Lau, Markham (CA); Marin Litoiu, Toronto (CA); Andrei Solomon, Mississauga (CA); Vincent F. Szaloky, Toronto (CA)

(73) Assignee: INTERNATIONAL BUSINESS MACHINES CORPORATION, Armonk, NY (US)

(21) Appl. No.: 13/620,700

(22) Filed: Sep. 14, 2012

(30) Foreign Application Priority Data
Oct. 21, 2011 (CA) 2755605

(51) Int. Cl. G06G 7/48

(52) U.S. Cl. 703/6

(57) ABSTRACT

An online simulation model optimization receives data representative of a business process captured in real time to form instance metrics, aggregates the instance metrics to form aggregated instance metrics, and uses a particle filter for filtering the aggregated instance metrics to form calibrated data. The process iteratively computes an output value using the calibrated data, by a simulation model. Responsive to a determination that the output value is not within a predetermined tolerance of an error threshold, the process adjusts a weight previously assigned to an aggregated instance metric by the particle filter to form recalibrated data, whereby the recalibrated data is submitted to the simulation model for computation. Responsive to a determination that the output value is within the predetermined tolerance, the process sends a result to a correction selection process of a business process optimizer, the result comprising the output value, the calibrated data, and/or the recalibrated data.

### BACKGROUND

This disclosure relates generally to business process modeling in a data processing system and more specifically to business process adaptation using a tracked simulation model in the data processing system.

A lack of tools for evaluating effects of designed solutions is a typical problem in business process re-engineering. Mistakes are often observed too late in the development cycle, for example, after implementation when a correction is difficult and expensive to apply. Using a simulation model to investigate system behavior may be less laborious, more flexible, cheaper, and safer than experimentation with a real production system.

Using a simulation model requires either generation of synthetic data or, ideally, real data for use in the process. Typical business process management systems (BPMS) provide monitoring capabilities enabling collection and storage of real data for use as input to a simulation model. The off-line simulation, although based on collected historical data, is accordingly outdated and typically does not reflect a running system.

For example, using input data derived from case studies correlated with actual past business outcomes typically provides a simulation model result which might not reflect an actual running business process. An optimization operation performed using the result accordingly might not be correct.

In another example, a business process integration and management solution (BPIM) is provided using a simulator, which simulates execution of the solution using a template, in the form of a simulation model. The analysis conducted can be questionable because the accuracy of the analysis is dependent on the historical accuracy of the solution template (simulation model), which is not enriched from runtime data.

In another example, integration of commercial off the shelf (COTS) products to form a coherent system for business process modeling is proposed. The proposed solution includes use of a static model in a simulation to provide process optimization.

Another proposed solution provides a method for managing (optimizing) a business process by utilizing feedback loops. The method gathers business data from a performance monitoring subsystem for use as feedback into a capacity management system, for optimization of the capacity management system. In a variation of the method, an autonomic system is adapted using a dynamic predictive performance model of the system.

Another proposed solution provides a method enabling simulation of business processes containing multiple discrete tasks. The method is directed toward the simulation system providing a modeling interface in which the model can be easily created and modified for iterative development.

Another proposed method improves upon a traditional business activity monitoring and management (BAM) architecture, in which a monitor subsystem collects data on a deployed business process in real time, and converts these data into prescribed business metrics displayed in a dashboard portion of a user interface. A user may take a selective action against certain business metrics calculated from the monitor subsystem rather than permitting the method to perform the action, which might not be desirable. The method proposes addition of a filter on the data (user selection) to avoid local operational improvements, which may deteriorate system-wide performance.

### BRIEF SUMMARY

According to one embodiment, a computer-implemented process for online simulation model optimization is presented. The computer-implemented process receives data representative of a business process captured in real time to form instance metrics; aggregates the instance metrics to form aggregated instance metrics; and filters, with a particle filter, the aggregated instance metrics to form calibrated data. The computer-implemented process iteratively computes an output value, by a simulation model, using the calibrated data. This iterative computing comprises: determining whether the output value is within a predetermined tolerance of an error threshold; and responsive to a determination that the output value is not within the predetermined tolerance of the error threshold, adjusting a weight previously assigned to an aggregated instance metric by the particle filter to form recalibrated data, whereby the recalibrated data is submitted to the simulation model for computation. Alternatively, responsive to a determination that the output value is within the predetermined tolerance of the error threshold, the iterative computing sends a result to a correction selection process of a business process optimizer, wherein the result is a value selected from a set of values including the output value, the calibrated data, and the recalibrated data.

Embodiments of these and other aspects of the present invention may be provided as a method, a system (apparatus), or a computer program product that comprises a computer recordable-type media containing computer-executable program code stored thereon. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

### BRIEF DESCRIPTION OF THE SEVERAL VIEWS OF THE DRAWINGS

For a more complete understanding of this disclosure, reference is now made to the following brief description, taken in conjunction with the accompanying drawings and detailed description, wherein like reference numerals represent like parts.

FIG. 1 is a block diagram of an exemplary network data processing system operable for various embodiments of the disclosure;

FIG. 2 is a block diagram of an exemplary data processing system operable for various embodiments of the disclosure;

FIG. 3 is a block diagram of a state estimator operable for various embodiments of the disclosure;

FIG. 4 is a block diagram of a business process optimization system in accordance with one embodiment of the disclosure;

FIG. 5 is a block diagram of a task duration vector in accordance with one embodiment of the disclosure; and

FIG. 6 is a flowchart of a tracked simulation process in accordance with an illustrative embodiment of the disclosure.

### DETAILED DESCRIPTION

Although an illustrative implementation of one or more embodiments is provided below, the disclosed systems and/or methods may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

As noted earlier, aspects of the present disclosure may be embodied as a system, method, or computer program product. Accordingly, aspects of the present disclosure may take the form of an entirely hardware embodiment, an entirely software embodiment (including firmware, resident software, micro-code, etc.), or an embodiment combining software and hardware aspects that may all generally be referred to herein as a “circuit”, “module”, or “system”. Furthermore, aspects of the present invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with the computer-readable program code embodied therein, for example, either in baseband or as part of a carrier wave. Such a propagated signal may take a variety of forms, including but not limited to electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wire line, optical fiber cable, radio frequency (RF), etc. or any suitable combination of the foregoing.

Computer program code for carrying out operations for aspects of the present disclosure may be written in any combination of one or more programming languages, including an object oriented programming language such as Java®, Smalltalk, C++, or the like and conventional procedural programming languages, such as the “C” programming language or similar programming languages. (Java and all Java-based trademarks and logos are trademarks of Oracle Corporation, and/or its affiliates, in the United States, other countries, or both.) The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide processes for implementing the functions/acts specified in the flowchart and/or block diagram block or blocks.

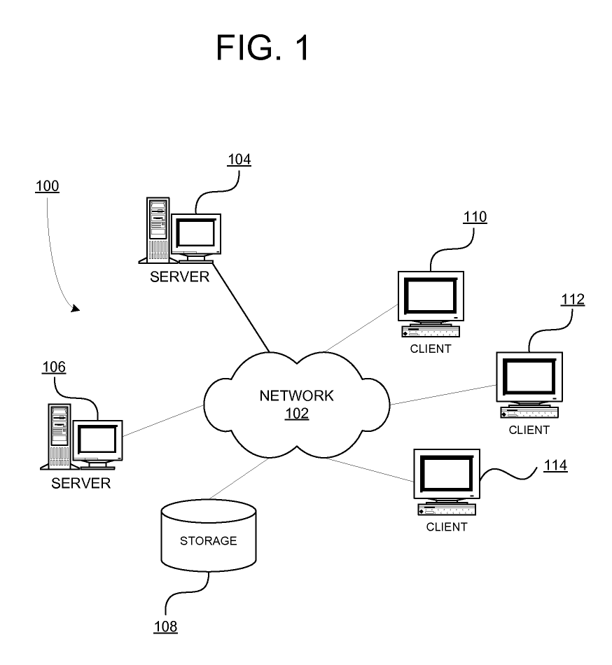

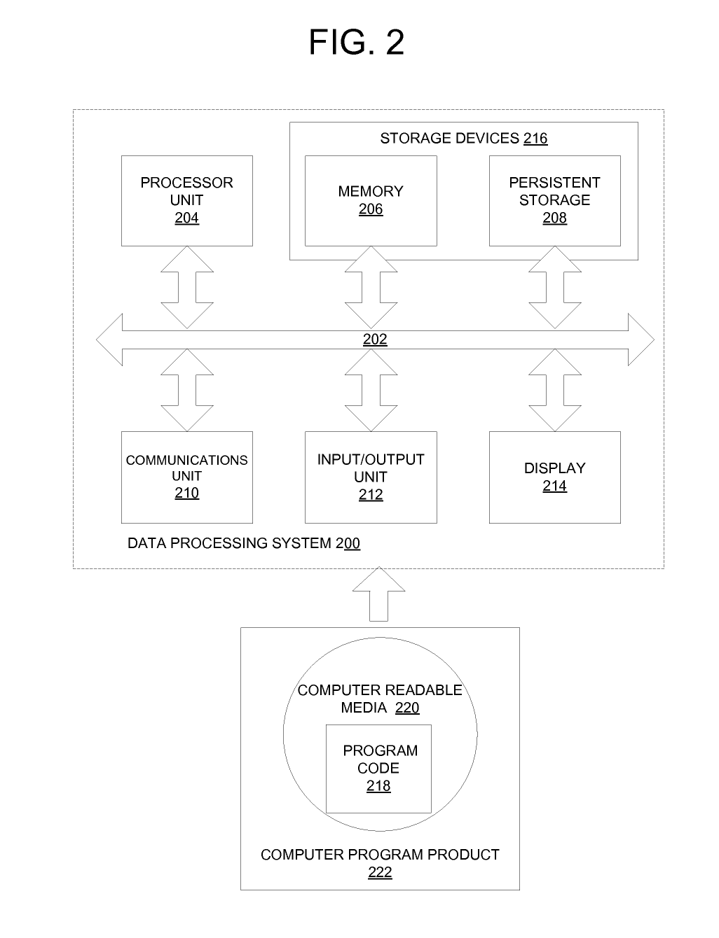

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference to FIG. 2, a block diagram of an exemplary data processing system operable for various embodiments of the disclosure is presented. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 for execution by processor unit 204. The processes of the different embodiments may be performed by processor unit 204 using computer-implemented instructions, which may be located in a memory, such as memory 206.

These instructions are referred to as program code, computer-usable program code, or computer-readable program code that may be read and executed by a processor in processor unit 204. The program code in the different embodiments may be embodied on different physical or tangible computer-readable storage media, such as memory 206 or persistent storage 208.

Program code 218 is located in a functional form on computer-readable storage media 220 that is selectively removable and may be loaded onto or transferred to data processing system 200 for execution by processor unit 204. Program code 218 and computer-readable storage media 220 form computer program product 222 in these examples. In one example, computer-readable storage media 220 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable storage media 220 also may take the form of a persistent storage, such as a hard drive, a thumb drive, or a flash memory that is connected to data processing system 200. The tangible form of computer-readable storage media 220 is also referred to as computer-recordable storage media. In some instances, computer-readable storage media 220 may not be removable.

Alternatively, program code 218 may be transferred to data processing system 200 from computer-readable storage media 220 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

In some illustrative embodiments, program code 218 may be downloaded over a network to persistent storage 208 from another device or data processing system for use within data processing system 200. For instance, program code stored in a computer-readable storage medium in a server data processing system may be downloaded over a network from the server to data processing system 200. The data processing system providing program code 218 may be a server computer, a client computer, or some other device capable of storing and transmitting program code 218.

Using data processing system 200 of FIG. 2 as an example, a computer-implemented process for online simulation model optimization is presented. Processor unit 204 receives data representative of a business process captured in real time to form instance metrics through communications unit 210, input/output unit 212, or storage devices 216 and aggregates the instance metrics to form aggregated instance metrics. Processor unit 204 filters the aggregated instance metrics to form calibrated data. Processor unit 204 iteratively computes an output value using the calibrated data by a simulation model and saves the output value in storage devices 216 for subsequent comparison with respective instance metrics. Processor unit 204, responsive to a determination that the output value is not within a predetermined tolerance of an error threshold, adjusts a weight previously assigned to an aggregated instance metric by a particle filter (as discussed below in further detail) to form recalibrated data, whereby the recalibrated data is submitted to the simulation model for computation; alternatively, responsive to a determination that the output value is within the predetermined tolerance of the error threshold, processor unit 204 sends a result to a correction selection process of a business process optimizer, wherein the result is a value selected from a set of values including the output value, the calibrated data, and the recalibrated data. Data representative of the business process may be received through communications unit 210 and network 102 from server 104 or client 110 (all of which are illustrated in network data processing system 100 of FIG. 1).

An illustrative embodiment of a process for evaluating the effects of designed solutions in a business process by business process adaptation using a tracked simulation model is presented. A tracked simulation model enables programmatic collection, analysis, and utilization of real data as inputs to the simulation model. A particle filter is used to accurately estimate input parameters to the simulation model using monitored instance metrics of the real data. The tracked simulation model adapts to changes in the workload and the system parameters by a feedback control scheme of the tracked simulation model. The feedback control scheme compares tracked simulation model output with process output and corrects the tracked simulation model input at run-time accordingly (for example, when there is a mismatch between simulator output and process output).

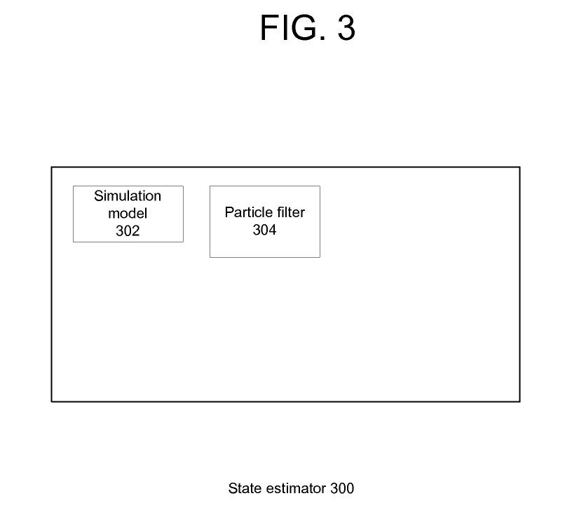

With reference to FIG. 3, a block diagram of a state estimator in accordance with various embodiments of the disclosure is presented. State estimator 300 is an example of a functional unit providing a capability to calibrate inputs (state parameters) of a simulation model. State estimator 300 represents a logical view in an embodiment of the disclosure, however the example is not meant to limit an implementation of an embodiment to the specific illustration.

State estimator 300 is a portion of a system comprising data acquisition and analysis for the purpose of accurately tuning a simulation model at runtime. State estimator 300 calibrates state parameters of the model to more accurately reflect unpredictable performance drifts of a real system. Operation of state estimator 300 comprises performing a recursive set of operations incorporating prediction and adjustment operations until a predetermined tolerance is achieved between observed business process values and corresponding simulated values. The refined output of state estimator 300 typically provides a capability to make better decisions regarding adjusting workload parameters and system parameters of the real system.

State estimator 300 is a functional element in a control loop comprising simulation model 302 and particle filter 304 to compute simulator parameter estimates that cannot be measured. Raw monitored data typically contains noise and hides other relevant information, such as branching probabilities or task service times without queuing delays. By smoothing the raw data into more refined data, also called aggregated measurements (alternatively referred to as aggregated metrics or aggregated data), the refined data (aggregated data) becomes valuable input for state estimator 300 when tracking hidden task service times parameters. Together with this new preprocessed data, state estimator 300 identifies the best input for the measured output by correcting the input measurements through estimation.

Simulation model 302, comprising a portion of state estimator 300, can be used as a basis of an autonomic computing loop. A feedback control scheme using a tracked simulation model in the form of simulation model 302 can manage changes in a workload and associated system parameters by accordingly changing an underlying information technology infrastructure, thereby maintaining acceptable key performance indicators of a business process. Simulation model 302 iteratively processes the aggregated data, in the form of estimated input (x), into an output (y) until an accepted level of tolerance for a modeling error is obtained, at which time a final version of output (y) is forwarded for subsequent use in the business process.

State estimator 300 also incorporates particle filter 304 to provide a capability of tuning simulation model 302 by filtering out noise (i.e., unwanted data) which would otherwise affect the accuracy of the simulations. State estimator 300 uses particle filter 304 (in an embodiment of the state estimator) to filter out the noise leaving a typically more accurate estimated input (x) to simulation model 302 for a given measured output (z) received from a business process monitor.

Particle filters, such as particle filter 304, also known as sequential Monte Carlo methods (SMC), are model estimation techniques based on simulation. Also known as a survival of the fittest, a general idea of the filter is derived from a natural way entities evolve. Having a population of sample inputs x₍ᵢ₎ from a known distribution, each sample is characterized by an importance weight factor w₍ᵢ₎ calculated by an observation function y₍ᵢ₎=g(x₍ᵢ₎). After a number of iterations, most successful particles survive by weight recalculation. The weights are used to estimate a final hidden variable x. When measurement functions are nonlinear and posterior probability of a state is non-Gaussian, conventional filters, such as the Extended Kalman Filter (EKF), may typically yield a large estimation error. Efforts to improve the EKF, which led to an Unscented Kalman Filter (UKF), provided improvement for certain problems, but divergence or poor approximation could still occur in some non-linear problems.

Particle filters are typically a much faster alternative to the Extended Kalman Filter (EKF) or Unscented Kalman Filter (UKF). The accuracy of the particle filters, however, depends on the sample size. With sufficient sample diversity, particle filters can typically be made more accurate than either of the Kalman filters. When the simulated sample size is not sufficiently large or lacks diversity among particles (e.g., contains many repeated points), the Kalman filters might suffer from sample impoverishment.

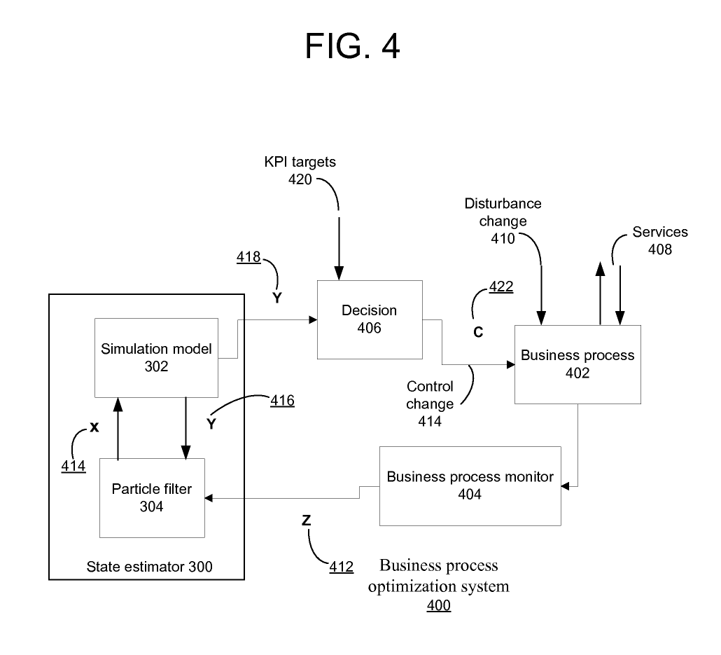

With reference to FIG. 4, a block diagram of a business process optimization system in accordance with various embodiments of the disclosure is presented. Business process optimization system 400 is an example of an optimization system using state estimator 300 of FIG. 3 to calibrate inputs (state parameters) of a simulation model using live data.

Business process optimization system 400 includes a number of components comprising business process 402, business process monitor 404, decision 406, and state estimator 300. Business process monitor 404 monitors and records instance metrics z 412 that are a collection of measurements resulting from each execution of business process 402. The instance metric typically contains key performance indicators of KPI targets 420 for instance metrics z 412, such as end-to-end process duration and service time values, which contribute as input to the simulation model such as task duration and decision nodes branching statistics.

Instance metrics z 412 are fed into state estimator 300, which calibrates the inputs (or state parameters) of the simulation model to reflect the real system's unpredictable performance drifts. The simulation input x 414 is computed iteratively using particle filter 304 to generate output y 416 inside state estimator 300 until an output of simulation model 306, generated as final output y 418, matches (within a certain error threshold) the measured KPIs of instance metrics z 412. The output of the simulation model, final output y 418, can then be compared against a set of KPI targets 420 (incorporating instance metrics z 412 and decision nodes probabilities of p to form zp), where decision 406 uses final output y 418 in identifying a suitable correction c 422 to bring instance metrics z 412 closer to zp as necessary.

Raw monitored data from business process monitor 404 often contains noise and hides other relevant information, as noted above. For example, monitored task duration will often include queuing delays when multiple instances of the process queue to process resources. However, simulation model 304 computes queuing delays as well, which results in simulation results not matching monitored metrics. To more accurately tune simulation model 304, noise which affects the accuracy of the simulations is filtered out using particle filter 302 to leave a best estimated input (x) 414 for a measured output of business process monitor 404 in the form of instance metrics z 412.

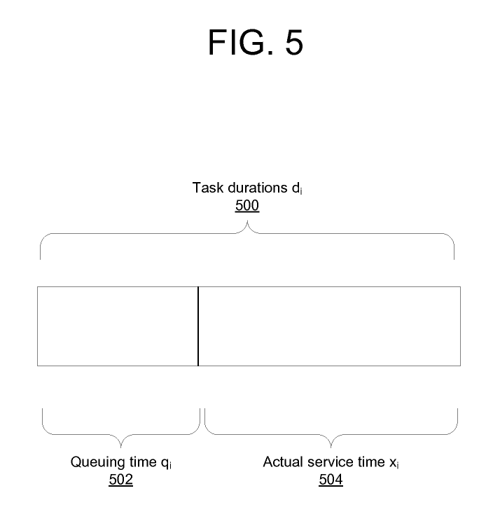

With reference to FIG. 5, a block diagram of a task duration vector in accordance with various embodiments of the disclosure is presented. Task duration vector 500 is an example of a portion of measurement vector, referred to herein as instance metrics z 412, which is used in a business process optimization system 400 of FIG. 4 to calibrate inputs (state parameters) of a simulation model of state estimator 300 of FIG. 3 using live data.

A monitor, such as business process monitor 404 of FIG. 4, records business process performance via instance metrics that are a collection of measurements resulting from each execution of the process. An instance metric contains three types of information: task durations, an end-to-end process duration, and decision nodes branching. A measurement vector, discussed above as instance metrics z 412, is a vector that contains task durations vector d 500 and the end-to-end duration of the execution e such that z=<d; e>, where d=<d₁ : : : ; dₙ). Each dᵢ; 1≦i≦n; represents the i^{th} task duration, wherein n is the total number of tasks in the process. All dᵢ comprising task durations vector 500 have two components, comprising a queuing time for the task specific resources (see queuing time qᵢ 502) and an actual service time xᵢ (see actual service time xᵢ 504), but both queuing time qᵢ 502 and actual service time xᵢ 504 are unknown. Therefore, an embodiment of the disclosed process measures all instances of task durations vector d 500 as dᵢ; 1≦i≦n and the end-to-end duration e to estimate all actual service time xᵢ; 1≦i≦n 504 at any moment in time to maintain synchronization of the simulation model with the real system.

Apart from instance metrics, measurement vector z also contains a chosen path of execution for each decision node during the execution of the process. For instance, for a decision node with a set of branches β, an execution is represented as a vector b=(b₁; : : : ; b_{|β|}>, where bᵢ=1 is the executed branch, and all other bₖ=0; ∀k/=i represent the unexecuted branches at that particular moment in time (where the notation ∀k/=i means “for all k not equal to i”).

Thus, for branch k at time step t and a window of size W, the probability that branch k is selected for execution is:

Using the described equation for P, all probabilities P_{b} for any given decision node bεD with a set of branches β, where D is the set of decision nodes of the process, can be calculated in which β is specific to each decision node b. All branch probabilities are put into vector P_{b}=<P(branch=1); : : : ; P(branch=|β|)> and finally all P_{b}; bεD are placed in a vector P=(Pᵢ; : : : ; P_{b}; : : : ; P|D|). Similarly, instance metrics z, components of dᵢ, and eᵢ of the last W instances at time step t are used in calculations using the described formula (wherein instances of d and e replace the variable b in the calculations).

In a similar manner, dₖ representing the mean and σ(dₖ) representing a standard deviation for task k duration, each over the last W number of instances, are calculated. The average end-to-end duration of the process e is also calculated using a similar equation.

At the end of this stage, instance metrics z has been aggregated across multiple instances using an average function, providing measurement vector z=(d; e), where d=(dᵢ: : : ; dₙ).

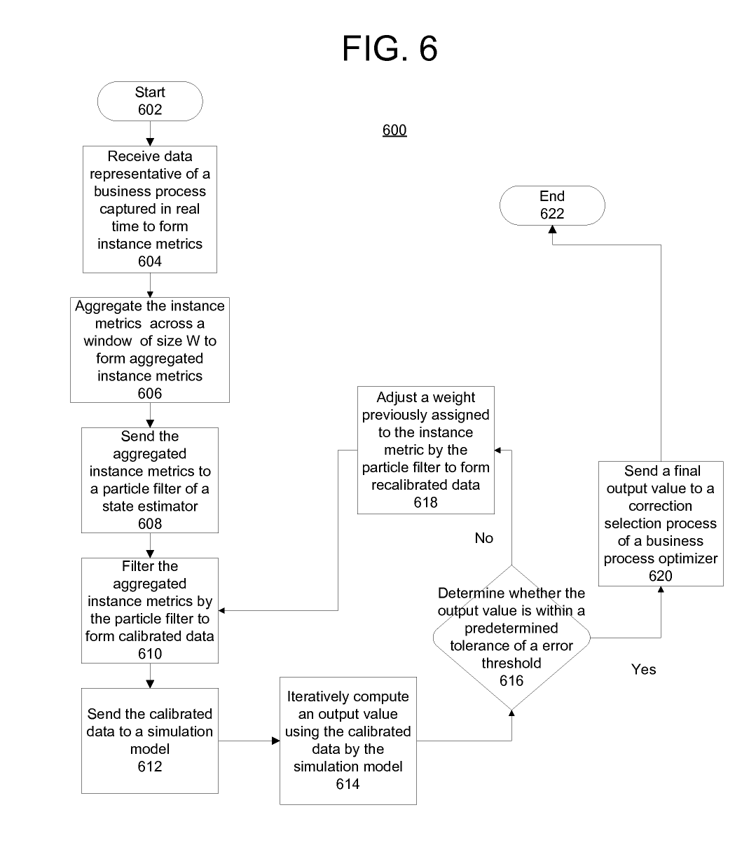

With reference to FIG. 6, a flowchart of a tracked simulation process in accordance with various embodiments of the disclosure is presented. Process 600 is an example of a tracked simulation process in an optimization system using state estimator 300 of FIG. 3 to calibrate inputs (state parameters) of a simulation model using live data.

Process 600 begins (step 602) and gathers (or receives) raw data captured as output representative of a business process during runtime in the form of instance metrics (step 604). The raw data is captured on-line, by periodically sampling an executing business process of a runtime. A monitor function typically provided with a business process modeler records the business process performance information as instance metrics, which are a collection of measurements resulting from each execution of the process. An instance metric contains types of information including task durations, an end-to-end process duration, and decision nodes branching probability information.

A measurement vector (containing instance metrics) that contains the task durations is referred to as vector z, as stated earlier. Vector z contains a measurement vector d that further contains elements representative of a measured duration of each task i and an end-to-end duration of execution represented as measurement vector e.

All instances dᵢ have components comprising a queuing time qᵢ (see 502 of FIG. 5) for task specific resources (and other noise) and actual task service time xᵢ (see 504 of FIG. 5), but both qᵢ and xᵢ are initially unknown. Therefore, all dᵢ are measured for 1≦i≦n and the end-to-end duration e. All xᵢ, for 1≦i≦n, are estimated at any moment in time to keep the simulation model synchronized with the real system. A value for xᵢ is estimated and provided as input to the simulation model rather than raw business process data received from a business process monitor in step 602.

Process 600 aggregates the instance metrics received across a certain movable or sliding window of size W to form aggregated instance metrics (step 606). Aggregate metrics are calculated across multiple instances using a function of interest (for example, average, maximum, minimum, sum, or count) to derive useful information about the process. For instance, branching probabilities at decision nodes are initially unknown, but can be deduced by creating an observation window that contains the last chosen number of executions as a function of time (for example, a last month) or a predefined number of instances (such as a last 100 instances).

For example, using a simple branch probability calculation based on a fixed window of size W=3, suppose that a change to a window of size W=4 results in a change of the yes branch probability of the last execution from 0% to 20%. Also, note that the window W has a smaller size for the first two executions, since there are not enough historical data for the initial few observations. As shown by this example, the window size affects the aggregated measure. In general, the more samples obtained, the more accurate the aggregated metrics. However, with real world applications, the method has to work at an adequate speed, trading and balancing accuracy for efficiency. Therefore, the size of the observation window or the time frame of an aggregated measure becomes a tuning parameter in the process.

The aggregation process creates a mean value for the instance metrics as well as a standard deviation. The aggregation operation is performed for measurement vector d, measurement vector e, and branching probabilities b over the window of size W. The window size is selectable to capture relevant data in conjunction with the sliding (moving) capability for capturing current data from the executing business process. The aggregation is performed using typical methods known to people skilled in the art of monitoring.

Process 600 sends the aggregated instance metrics to a particle filter of a state estimator (step 608). The aggregated instance metrics are processed by the particle filter in process 600 to form calibrated data (step 610). The particle filter of the state estimator is a component in the business process optimization loop. Process 600 applies particle filtering to estimate vector xᵢ by filtering out the noise (typically associated with queuing and overhead) from the measured task durations represented by dᵢ.

Input to the particle filter includes values representing a vector of measured average task duration, a vector of decision probabilities (e.g., the probability of branching), a number of tokens representing the observations (samples) within the window W or predetermined number of observations, inter-arrival times of sample elements, a vector of standard deviations, and a predetermined error threshold. The predetermined error threshold is a value representing an acceptable margin of error between an estimated value derived through the state estimator and an instance metric received as a process sample measurement. A small, predetermined error threshold value implies a high level of accuracy between a simulated result and a corresponding observed result.

The particle filter portion of process 600 initializes the task execution times for each task with task measured duration times and further generates random values (i.e., noise), having normal distribution, around the task measured duration, and these combined values are now referred to as particles. A weight is assigned to each particle, in which the weight w⁽ⁱ⁾ signifies the importance of a specific particle. An overall estimate of the state of the system is obtained by the weighted sum of all the particles. The particle filter sub-process is recursive in nature and operates in two phases, a prediction phase and a subsequent update phase. In order to simulate the effect of noise on input x, each particle is updated with the estimated system state variable (during the prediction stage) and some random noise. Each particle is simulated, the result of which is compared to a last (i.e., latest/newest) observation, and a respective weight is re-evaluated accordingly (during the update stage). A new estimation of the system state x is obtained by the weighted sum of the new particle weights, and a new generation of particles is updated using this last estimation.

Process 600 sends the calibrated data to a simulation model (step 612). Process 600 iteratively computes an output value using the calibrated data in a simulation model (step 614). The result is a simulation model potentially synchronized with real business process execution times for each task.

During the iterative computation, the simulation model receives all particle combinations and simulates a respective portion of the business process. The simulation model also uses the inter-arrival time, the number of requests (where each request represents a unit of work), and the decision nodes probabilities vector in performing simulations. A real duration for a task is thus estimated using a set of particle subcomponents (i.e., the measured duration times and randomly-generated noise values) described previously. As described in the previous section, all subcomponents for a task are initialized with a duration value as measured. A particle subcomponent with an associated noise value that is closest to a real execution time, when used as input in the simulation model, produces a smallest error and is accordingly assigned a highest weight. Particles having a higher weight survive for longer periods of the process due to their relative importance over particles having a lesser weight.

Process 600 calculates and stores a modeling error between a simulated end-to-end response time and a measured end-to-end response time. Process 600 recalculates the weights of each particle by rewarding particles having small modeling errors with assignment of higher weights. Process 600 recalculates the task execution times using the new weighted sum of the particles (not shown in FIG. 6).

Process 600 determines whether the output value y of the simulation model is within a predetermined tolerance of an error threshold (step 616). Responsive to a determination that the output value y is not within the predetermined tolerance of the error threshold, process 600 adjusts a weight previously assigned to an aggregated instance metric by the particle filter to form recalibrated data, whereby the recalibrated value is submitted to the simulation model for computation (step 618) for an iterative processing thereof.

The goal of particle filtering is to estimate the state variables' representation of a task execution time from a set of observations that arrive sequentially over time. Multiple copies of values representative of task execution times are used in the estimation, each associated with a weight, w⁽ⁱ⁾, that signifies the importance of that specific particle. An overall estimate of the state of the system is obtained by the weighted sum of all particles.

The particle filter sub-process of the state estimator is recursive in nature and operates in a prediction phase and an update phase, as noted earlier. To simulate the effect of noise on a state variable representation of a task execution time, each particle is updated with the estimated system state variable (during the prediction stage) and a random noise component. Each particle is simulated, the result is compared to the last observation, and the weight is re-evaluated (during the update stage).

For example, in an embodiment of the disclosed process in which the importance of good particles is emphasized,

$${w}^{( i )} = \frac{1}{{ɛ}^{{( i )}^{2}}}$$

is used to provide typically faster convergence and therefore better results for the same number of iterations than a slower convergence. After the weight normalization, the estimation components representative of task execution times are updated by the weighted sum of the new contributions w⁽ⁱ⁾ of each particle and respective old values representative of task execution times. A new estimation of the system state variable representation of a task execution time is obtained by a weighted sum of the new particle weights, and a new generation of particles is updated using this last (i.e., new) estimation.

From step 618, process 600 loops back to perform step 610 to recalibrate data whereby the recalibrated data is submitted to the simulation model for an iterative computation, using the particle filter as before. Referring again to step 616, responsive to a determination that the output value y of the simulation model is within the predetermined tolerance of the error threshold, process 600 sends the output as a final value y to a correction selection process of a business process optimizer (step 620) and terminates thereafter (step 622). In an alternative embodiment, the output value sent at step 620 from the state estimator to the decision block (see 406 in FIG. 4) of the correction selection process of the business process optimizer can and might contain both the simulation output y and the iteratively calibrated simulation input x (or recalibrated version thereof). One or more values may be sent because the decision block 406 can and might make use of the iteratively calibrated simulation inputs as well as the simulation output y for determining optimization decisions. Accordingly, the communicated result is a value selected from a set of values including the output value, the calibrated data, and the recalibrated data.

Thus is presented, in an illustrative embodiment, a computer-implemented process for online simulation model optimization. In summary, the computer-implemented process receives data representative of a business process captured in real time to form instance metrics, aggregates the instance metrics to form aggregated instance metrics, and applies a particle filter to filter the aggregated instance metrics to form calibrated data. The computer-implemented process iteratively computes an output value using the calibrated data, by a simulation model. Responsive to a determination that the output value is not within a predetermined tolerance of an error threshold, the process adjusts a weight previously assigned to an aggregated instance metric by the particle filter to form recalibrated data, whereby the recalibrated data is submitted to the simulation model for computation. Alternatively, responsive to a determination that the output value is within the predetermined tolerance of the error threshold, the process sends a result to a correction selection process of a business process optimizer, wherein the result is a value selected from a set of values including the output value, the calibrated data, and the recalibrated data.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing a specified logical function. It should also be noted that, in some alternative implementations, the functions noted in the blocks might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The described embodiment was chosen and described in order to best explain the principles of the invention and the practical application, and to enable others of ordinary skill in the art to understand the invention for various embodiments with various modifications as are suited to the particular use contemplated.

As noted earlier, the invention can take the form of an entirely hardware embodiment, an entirely software embodiment, or an embodiment containing both hardware and software elements. In a preferred embodiment, the invention is implemented in software, which includes but is not limited to firmware, resident software, microcode, and other software media that may be recognized by one skilled in the art.

It is important to note that while the present invention has been described in the context of a fully functioning data processing system, those of ordinary skill in the art will appreciate that the processes of the present invention are capable of being distributed in the form of a computer-readable medium of instructions and a variety of forms and that the present invention applies equally regardless of the particular type of signal-bearing media actually used to carry out the distribution. Examples of computer-readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer-readable media may take the form of coded formats that are decoded for actual use in a particular data processing system.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

What is claimed is:

1. A computer-implemented process for online simulation model optimization, the computer-implemented process comprising:
receiving data representative of a business process captured in real time to form instance metrics;
aggregating the instance metrics to form aggregated instance metrics;
filtering the aggregated instance metrics, using a particle filter, to form calibrated data; and
iteratively computing an output value, by a simulation model, using the calibrated data, further comprising:
determining whether the output value is within a predetermined tolerance of an error threshold;
responsive to a determination that the output value is not within the predetermined tolerance of the error threshold, adjusting a weight previously assigned to an aggregated instance metric by the particle filter to form recalibrated data, wherein the recalibrated data is submitted to the simulation model for computation of the output value; and
responsive to a determination that the output value is within the predetermined tolerance of the error threshold, sending a result to a correction selection process of a business process optimizer, wherein the result is a value selected from a set of values including the output value, the calibrated data, and the recalibrated data.

2. The computer-implemented process of claim 1, wherein the instance metrics further comprise:
a collection of measurements resulting from each execution of the business process, each instance metric comprising at least one of task durations information, an end-to-end process duration information, and decision nodes branching information.

3. The computer-implemented process of claim 1, wherein the aggregating further comprises:
smoothing the instance metrics across multiple instances using a function of interest selected from a set of functions including average, maximum, minimum, sum, and count, wherein the smoothing further comprises calculating a mean and a standard deviation for each of a plurality of task nodes and calculating branching probabilities representative of each potential branch associated with each respective instance of the instance metrics.

4. The computer-implemented process of claim 1, wherein the filtering further comprises:
estimating state variables from a set of observations that arrive sequentially over a time period, wherein multiple copies of the state variables are used;
generating a set of noise vectors having normal distribution;
adding a noise value of the set of noise vectors to each estimation variable according to a standard deviation of a respective estimation variable in the set of observations to create a particle; and
for each created particle, associating a weight with the created particle, the weight signifying an importance of the created particle.

5. The computer-implemented process of claim 1, wherein:
the determining further comprises comparing the output value of the simulation model to a last observation of the business process; and
the adjusting further comprises:
re-evaluating the weight previously assigned to form a new particle; and
forwarding the new particle to the simulation model as the recalibrated data.

6. The computer-implemented process of claim 1, wherein the determining further comprises:
calculating a weighted sum of a plurality of particles to form the output value, wherein the weighted sum represents an overall estimate of a state of a system in which the business process operates.

7. The computer-implemented process of claim 1, wherein input data for the filtering further comprises:
a vector of average task durations, a vector of decision nodes probabilities, a number of tokens representing a set of observations, an inter-arrival time for the set of observations, a vector of standard deviations representative of the task durations, and a predetermined error threshold value.

8. A computer program product for online simulation model optimization, the computer program product comprising at least one computer-readable media containing computer-executable program code stored thereon, the computer-executable program code configured for:
receiving data representative of a business process captured in real time to form instance metrics;
aggregating the instance metrics to form aggregated instance metrics;
filtering the aggregated instance metrics, using a particle filter, to form calibrated data; and
iteratively computing an output value, by a simulation model, using the calibrated data, further comprising:
determining whether the output value is within a predetermined tolerance of an error threshold;
responsive to a determination that the output value is not within the predetermined tolerance of the error threshold, adjusting a weight previously assigned to an aggregated instance metric by the particle filter to form recalibrated data, whereby the recalibrated data is submitted to the simulation model for computation of the output value; and
responsive to a determination that the output value is within the predetermined tolerance of the error threshold, sending a result to a correction selection process of a business process optimizer, wherein the result is a value selected from a set of values including the output value, the calibrated data, and the recalibrated data.

9. The computer program product of claim 8, wherein the instance metrics further comprise:
a collection of measurements resulting from each execution of the business process, each instance metric comprising at least one of task durations information, an end-to-end process duration information, and decision nodes branching information.

10. The computer program product of claim 8, wherein the aggregating further comprises:
smoothing the instance metrics across multiple instances using a function of interest selected from a set of functions including average, maximum, minimum, sum, and count, wherein the smoothing further comprises r calculating a mean and a standard deviation for each of a plurality of task nodes and calculating branching probabilities representative of each potential branch associated with each respective instance of the instance metrics.

11. The computer program product of claim 8, wherein the filtering further comprises:
estimating state variables from a set of observations that arrive sequentially over a time period, wherein multiple copies of the state variables are used;
generating a set of noise vectors;
adding a noise value of the set of noise vectors, having normal distribution, to each estimation variable according to a standard deviation of a respective estimation variable in the set of observations to create a particle; and
for each created particle, associating a weight with the created particle, the weight signifying an importance of the created particle.

12. The computer program product of claim 8, wherein:
the determining further comprises comparing the output value of the simulation model to a last observation of the business process; and
the adjusting further comprises:
re-evaluating the weight previously assigned to form a new particle; and
forwarding the new particle to the simulation model as the recalibrated data.

13. The computer program product of claim 8, wherein the determining further comprises:
calculating a weighted sum of a plurality of particles to form the output value, wherein the weighted sum represents an overall estimate of a state of a system in which the business process operates.

14. The computer program product of claim 8, wherein input data for the filtering further comprises:
a vector of average task durations, a vector of decision nodes probabilities, a number of tokens representing a set of observations, an inter-arrival time for the set of observations, a vector of standard deviations representative of the task durations, and a predetermined error threshold value.

15. An apparatus for online simulation model optimization, the apparatus comprising:
a communications fabric;
a memory connected to the communications fabric, wherein the memory contains computer-executable program code;
a communications unit connected to the communications fabric;
an input/output unit connected to the communications fabric;
a display connected to the communications fabric; and
a processor unit connected to the communications fabric, wherein the processor unit executes the computer-executable program code to direct the apparatus to implement functions comprising:
receiving data representative of a business process captured in real time to form instance metrics;
aggregating the instance metrics to form aggregated instance metrics;
filtering the aggregated instance metrics, using a particle filter, to form calibrated data; and
iteratively computing an output value, by a simulation model, using the calibrated data, further comprising:
determining whether the output value is within a predetermined tolerance of an error threshold;
responsive to a determination that the output value is not within the predetermined tolerance of the error threshold, adjusting a weight previously assigned to an aggregated instance metric by the particle filter to form recalibrated data, whereby the recalibrated data is submitted to the simulation model for computation of the output value; and
responsive to a determination that the output value is within the predetermined tolerance of the error threshold, sending a result to a correction selection process of a business process optimizer, wherein the result is a value selected from a set of values including the output value, the calibrated data, and the recalibrated data.

16. The apparatus of claim 15, wherein the instance metrics further comprise:
a collection of measurements resulting from each execution of the business process, each instance metric comprising at least one of task durations information, an end-to-end process duration information, and decision nodes branching information.

17. The apparatus of claim 15, wherein the aggregating further comprises:
smoothing the instance metrics across multiple instances using a function of interest selected from a set of functions including average, maximum, minimum, sum, and count, wherein the smoothing further comprises calculating a mean and a standard deviation for each of a plurality of task nodes and calculating branching probabilities representative of each potential branch associated with each respective instance of the instance metrics.

18. The apparatus of claim 15, wherein the filtering further comprises:
estimating state variables from a set of observations that arrive sequentially over a time period, wherein multiple copies of the state variables are used;
generating a set of noise vectors having normal distribution;
adding a noise value of the set of noise vectors to each estimation variable according to a standard deviation of a respective estimation variable in the set of observations to create a particle; and
for each created particle, associating a weight with the created particle, the weight signifying an importance of the created particle.

19. The apparatus of claim 15, wherein:
the determining further comprises comparing the output value of the simulation model to a last observation of the business process; and
the adjusting further comprises:
re-evaluating the weight previously assigned to form a new particle; and
forwarding the new particle to the simulation model as the recalibrated data.

20. The apparatus of claim 15, wherein the determining further comprises:
calculating a weighted sum of a plurality of particles to form the output value, wherein the weighted sum represents an overall estimate of a state of a system in which the business process operates.
